(19) United States
(12) Patent Application Publication
(10) Pub. No.: US 2017/0097591 A1
(43) Pub. Date: Apr. 6, 2017

(54) TRANSFERRING ROLLER, TRANSMISSION ASSEMBLY, AND OFFICE MACHINE USING THE SAME

(71) Applicant: Avision Inc., Hsinchu (TW)

(72) Inventors: Sheng-Yao SHIH, Hsinchu (TW); Bo-Wei CHANG, Hsinchu (TW)

(21) Appl. No.: 15/268,419

(22) Filed: Sep. 16, 2016

(30) Foreign Application Priority Data
Oct. 6, 2015 (TW) 104132753

(51) Int. Cl. G03G 15/00

(52) U.S. Cl. CPC G03G 15/162

(57) ABSTRACT

A office machine including a data carrier transferring passage and a transmission assembly disposed in the data carrier transferring passage is provided. The transmission assembly includes a shaft disposed along a pivoting axial and a transferring roller pivoted with the shaft, wherein the transferring roller rotates along the pivoting axial. The transferring roller includes a body and multiple grooves. The body has a transferring surface and two supporting surfaces. The two supporting surfaces are connected with two sides of the transferring surface and pivoted with the shaft. The grooves are arranged on the transferring surface, wherein each groove has two end portions. At least one of the two end portions is not connected to the supporting surfaces.

The current application claims a foreign priority to application number 104132753 filed on Oct. 6, 2015 in Taiwan.

### BACKGROUND OF THE INVENTION

Field of the Invention

The present invention relates to a transferring roller, and a transmission assembly and a office machine using the same, and more particularly, the present invention relates to a transferring roller, and a transmission assembly and a office machine using the same for transferring a data carrier.

Description of Related Art

Conventional multi-function machines, such as a scanner, a copier, or other office machine with multi-functions, have an automatic feeding device (or named as automatic document feeder, ADF) for a user to add or scan plural sheets one time without manual operation.

FIG. 1 is a schematic view illustrating a transferring roller in the prior art. Referring to FIG. 1, the transferring roller 10 of the prior art is, for example, applied in the office machine for transferring a data carrier, wherein the data carrier is, for example, sheet. Multiple groove 12 are configured on the wheel-surface of the transferring roller 10. Worth mention, each groove 12 of the prior art is configured across entire wheel-surface of transferring roller 10, and all grooves 12 are arranged around entire wheel-surface.

However, in the prior art, due to the configuration of each groove 12 is across entire wheel-surface, and all grooves 12 are arranged around entire wheel-surface, so that noise can be generated easily when the data carriers, such as sheets, are transferred by the transferring roller 10. In detail, when the sheets are transferred by the transferring roller 10, the contacting region between the transferring roller 10 and the sheets covers the groove which across entire wheel-surface and the entity wheel-surface. The contacting force between the sheet and the entity wheel-surface is different from the force in the non-contacting state (such as the position of grooves) between the sheet and the entity wheel-surface. Therefore, when the sheets are transferred, the driving force generated from each tangent surface of the transferring roller 10 for the sheet is inconsistent obviously, and result the generation of the wrinkles and the noise in the transferring process. Furthermore, when the sheets be with wrinkles, paper jams are occurred more likely, and result in the trouble of sheets transferring process.

In short, when the contacting force of each sheet section with the transferring roller 10 is inconsistent obviously, the transferring process of the sheets will be in a state of instability easily, and influences the smoothness and flatness of sheets in the feeding process.

### SUMMARY OF THE INVENTION

Accordingly, an object of the present invention is to provide a transferring roller, and a transmission assembly and a office machine having the same, which can guide the data carrier stably and quietly for transferring various kinds of data carriers smoothly.

To achieve the foregoing and other objects, a transferring roller is provided for transferring a data carrier. The transferring roller comprises a body and multiple grooves. The body has a transferring surface and two supporting surfaces, each supporting surface is connected to two sides of the transferring surface respectively. The grooves are arranged in the transferring surface, and each groove has two groove ends, wherein at least one of the groove ends is not connected to the supporting surface. The transferring roller rotates in a axis of the pivoting axial along a feeding direction for transferring the data carrier.

To achieve the foregoing and other objects, a transmission assembly is further provided, which rotates along a feeding direction to transfer a data carrier. The transmission assembly comprises a shaft and a transferring roller. The shaft is disposed along a pivoting axial. The transferring roller is pivoted with the shaft, and rotates in a axis of the pivoting axial. The transferring roller comprise a body and multiple grooves. The body has a transferring surface and two supporting surfaces, each supporting surface is connected to two sides of the transferring surface respectively, and the supporting surfaces and the shaft are pivoted with each other. The grooves are arranged in the transferring surface, and each groove has two groove ends, at least one of the groove ends is not connected to the supporting surface.

To achieve the foregoing and other objects, a office machine is further provided, which comprises a data carrier transferring passage and a transmission assembly. The transmission assembly is disposed in the data carrier transferring passage, and rotates to transfer a data carrier along a feeding direction. The transmission assembly comprises a shaft and a transferring roller. The shaft is disposed along a pivoting axial. The transferring roller is pivoted with the shaft, and rotates in a axis of the pivoting axial. The transferring roller comprises a body and multiple grooves. The body has a transferring surface and two supporting surfaces, each supporting surface is connected to two sides of the transferring surface respectively, and the supporting surfaces and the shaft are pivoted with each other. The grooves are arranged in the transferring surface, and each groove has two groove ends, at least one of the groove ends is not connected to the supporting surface.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic view illustrating a transferring roller in the prior art.

FIG. 2 is a schematic view illustrating a office machine according to one embodiment of the present invention.

FIG. 3A is a schematic view illustrating the transmission assembly depicted in FIG. 2. FIG. 3B is a exploded view illustrating the transmission assembly depicted in FIG. 3A.

FIG. 4 is a schematic view illustrating the transmission assembly depicted in FIG. 3A without the shaft.

FIG. 5 is a schematic view illustrating a transmission assembly according to another embodiment of the present invention.

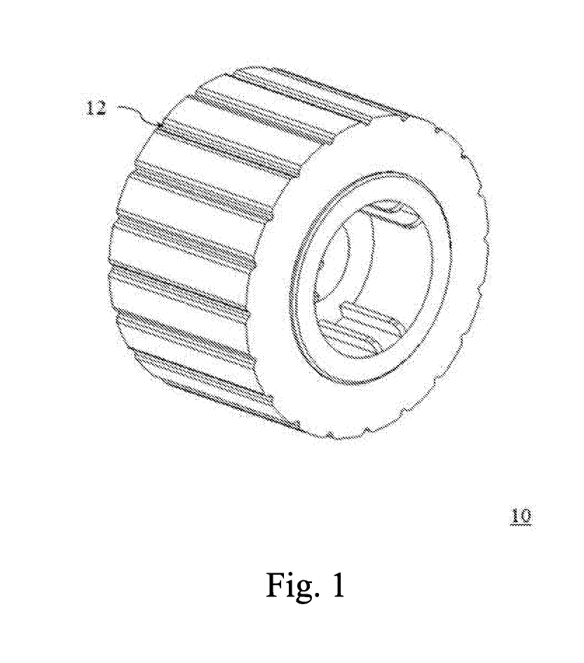

### DESCRIPTION OF EMBODIMENTS

The characteristics, contents, advantages and achieved effects of the present invention will become more fully understood from the detailed description given herein below and the accompanying drawings which are given by way of illustration only, and thus are not limitative of the present invention.

As required, detailed embodiments are disclosed herein. It must be understood that the disclosed embodiments are merely exemplary of and may be embodied in various and alternative forms, and combinations thereof. As used herein, the word “exemplary” is used expansively to refer to embodiments that serve as illustrations, specimens, models, or patterns. The figures are not necessarily to scale and some features may be exaggerated or minimized to show details of particular components. In other instances, well-known components, systems, materials, or methods that are known to those having ordinary skill in the art have not been described in detail in order to avoid obscuring the present disclosure. Therefore, specific structural and functional details disclosed herein are not to be interpreted as limiting, but merely as a basis for the claims and as a representative basis for teaching one skilled in the art.

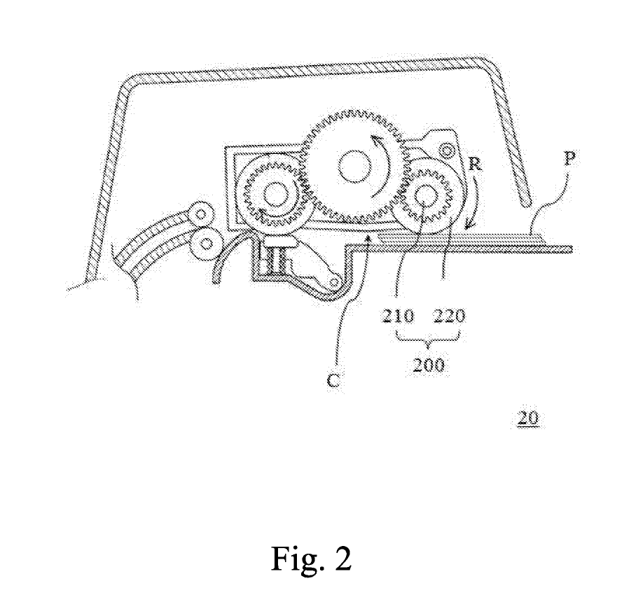

FIG. 2 is a schematic view illustrating a office machine according to one embodiment of the present invention. Referring to FIG. 2, a office machine 20 of the present embodiment is suitable for guiding data carriers P stably and quietly and executing the transferring process smoothly. The data carriers P are, for example, sheets, documents, or various kinds of cards prepared for printing. The data carriers also can be the sheets, documents, or various kinds of cards which have been printed with information, and does not constrained in the present invention. In the present embodiment, the office machine 20 comprises a data carrier transferring passage C and a transmission assembly 200. Wherein, the transmission assembly 200 is disposed in the data carrier transferring passage C, and rotates along a feeding direction R for transferring the data carriers P. In the present invention, the transmission assembly 200 is a roller assembly, and the roller assembly of the present embodiment is described in an example of the pickup roller assembly. A friction is generated between the pickup roller assembly and the data carriers P for feeding the data carriers P into the data carrier transferring passage C. In addition, the office machine 20 shown in FIG. 2 is used to present primarily that the transmission assembly 200 is suitable for transferring data carriers P in the data carrier transferring passage C, the components except the transmission assembly 200 shown in FIG. 2 are just be taken as examples, and does not constrained in the present invention.

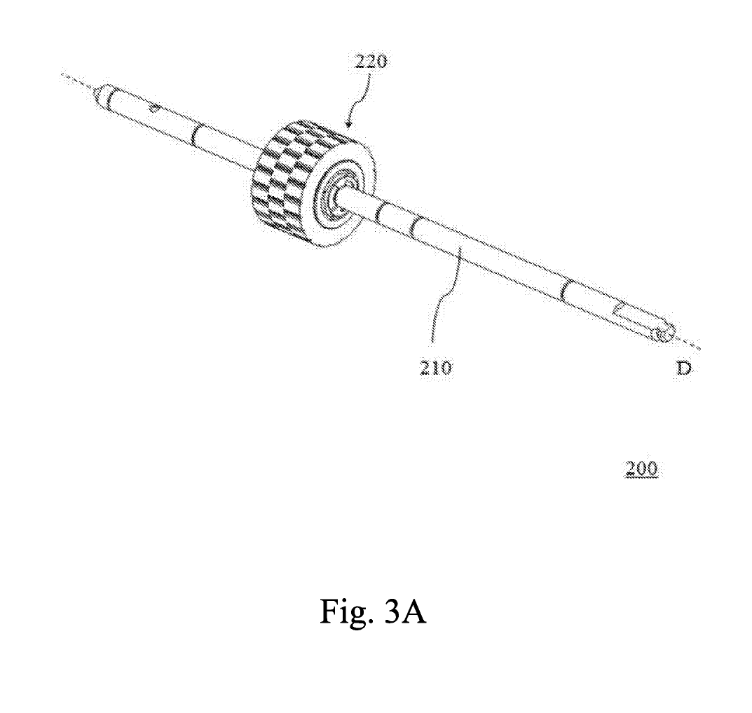

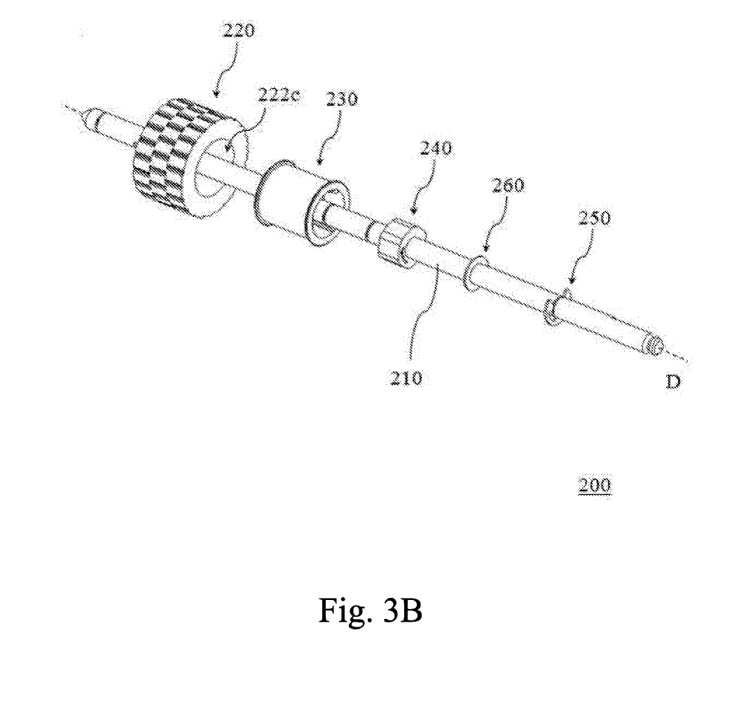

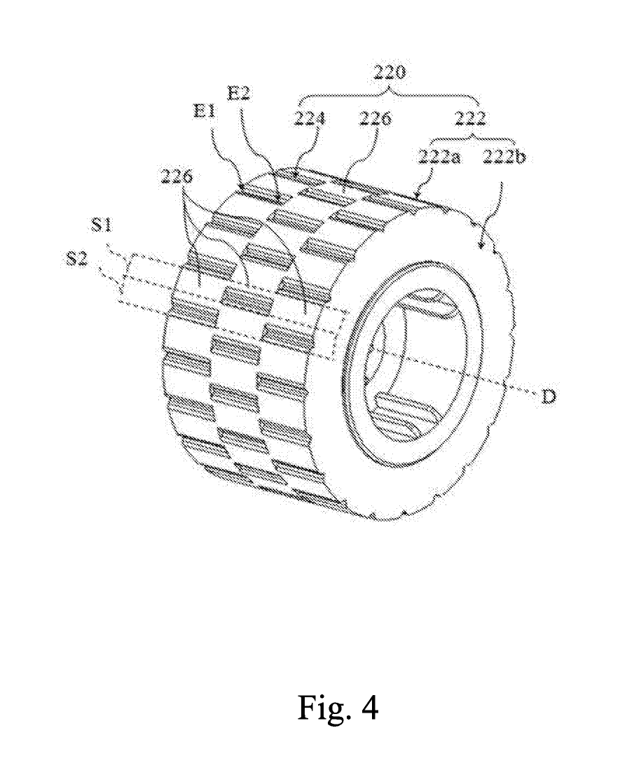

Referring to FIG. 3A, FIG. 3B and FIG. 4, wherein FIG. 3A is a schematic view illustrating the transmission assembly depicted in FIG. 2, FIG. 3B is a exploded view illustrating the transmission assembly depicted in FIG. 3A, and FIG. 4 is a schematic view illustrating the transmission assembly depicted in FIG. 3A without the shaft. In the present embodiment, the transmission assembly 200 comprises a shaft 210 and a transferring roller 220. Wherein, the shaft 210 is disposed along a pivoting axial D, and the transferring roller 220 is pivoted with the shaft 210 and rotates in a axis of the pivoting axial D. The rotating direction of the transferring roller 220 is the feeding direction R, and the feeding direction R is, for example, vertical to the pivoting axial mutually.

From above, the transferring roller 220 comprises a body 222 and multiple grooves 224, wherein each groove 224 has two groove ends E1, E2. Besides, the body 222 is, for example, a wheel-like structure, and has a transferring surface 222a and two supporting surfaces 222b, wherein the grooves 224 are arranged on transferring surface 222a. The transferring surface 222a is, for example, a annular surface configured around the wheel-like structure, and the two supporting surfaces 222b are the structural surfaces which connected to two sides of the annular surface respectively. In addition, the two supporting surfaces 222b and the shaft 210 are pivoted with each other. Wherein, the material of the transferring roller 220 can be rubber.

Worth mention, the transferring roller 220 further comprises multiple guiding units 226 Similar to the grooves 224, the guiding units 226 are also arranged on transferring surface 222a. In the present embodiment, the guiding units 226 are arranged on the transferring surface 222a entirely. In detail, the guiding units 226 are configured on the transferring surface 222a in a spaced arrangement by the design of the configuration of multiple grooves 224. In the present embodiment, except to define the configuration of the guiding units 226, the design of the grooves 224 also can be used to housed the dust particles or toner particles dropped down from the toner cartridge or the printed sheets so as to reduce the influences for the friction of the guiding units 226. Therefore, the design of the guiding unit 226 can provides a driving force (friction) for the data carriers P effectively, and drive the data carriers P contacted with the transferring surface 222a be feed into the interior of the office machine 20 by the transferring roller 220.

Taking an example of the transferring roller 220 shown in FIG. 4, in the present embodiment, the guiding units 226 and the grooves 224 are configured in a spaced arrangement along the pivoting axial D. Simultaneously , the guiding units 226 and the grooves 224 are also configured in a spaced arrangement along the feeding direction R. Therefore, each groove 224 can distinguish or define at least three guiding units 226, for example. As a result, at least a guiding unit 226 and at least a groove 224 are configured on a tangent surface which be in the transferring surface 222a of the transferring roller 220 along the pivoting axial D simultaneously. The tangent surface is the partial surface of the transferring roller 220 contacted with the data carriers P when the transmission assembly 200 be in the transferring process.

In FIG. 4, three guiding units 226 and one groove 224 are configured on one tangent surface Si which be in the transferring surface 222a along the pivoting axial D simultaneously. This is, the three guiding units 226 configured on the tangent surface of the transferring surface 222a along the pivoting axial are located in the same horizontal plane, and part of the guiding units are connected with each other. Similarly, in one tangent surface S2 adjacent to the tangent surface 51, three guiding units 226 and two grooves 224 be configured thereon. The foregoing description about the amount of the guiding units 226 and grooves 224 configured on the tangent surface is depended on the defined position of the tangent surface, the amount of the guiding units 226 and groove 224s is not limited in the present invention.

In order to configure at least a guiding unit 226 and at least a groove 224 on the tangent surface of the transferring roller 220 along the pivoting axial D simultaneously, each groove 224 of the present embodiment is not across the entire transferring surface 222a along the pivoting axial D. This is, in the present embodiment, at least one of the two groove ends E1, E2 in each groove 224 is not connected to the supporting surface 222b of the body 222. In other words, at least one of the grooves end E1, E2 is connected to the guiding unit 226.

As a result, when the transmission assembly 200 be in the transferring process, the surface (tangent surface) of the transferring roller 220 contacted with the data carriers P is configured with at least a guiding unit 226 and at least a groove 224 simultaneously, and then each contacting surface (tangent surface) of the transferring surface 222a can provide the driving force for each section of the data carrier P. Wherein, the subjected driving force in each section of the data carrier P are almost consistency. When the data carriers P are sheets, the office machine 20 of the present invention can have less noise obviously and can reduce the generation of wrinkled sheets. This ensures that the sheets can be intact without damage in the transferring process. Furthermore, when the contacting force of each tangent surface in the sheets is consistent obviously, the sheets can be transferred stably and quietly, and then pass through the gap between the sheet-separating roller and the paper passage, or the gap between pickup roller and the sheet-separating roller without the situation of paper jams. In the present invention, the smoothness of the feeding process can be increased greatly.

In addition, in a preferred embodiment, the tangent surface of the transferring surface 222a along the pivoting axial is a plane substantially, which make the transferring roller 220 have more contacting regions with the data carriers P, the data carriers P are, for example, the sheets. Thus, the design of the present invention can drive the data carriers P effectively and stably.

Referring to FIG. 2, FIG. 3A, FIG. 3B and FIG. 4 continuously, the transmission assembly 200 of the present embodiment further comprises a regulating element 230, a unidirectional restricting element 240, a positioning element 250, and a gasket 260. Wherein, the regulating element 230 is disposed in the transferring roller 220. In detail, the body 222 of the transferring roller 220 is, for example, configured with a housing space 222c located in the center of the body 222. The unidirectional restricting element 240 is pivoted with the shaft 210. The transferring roller 220 of the present embodiment is fixed around the unidirectional restricting element 240 by the regulating element 230. In addition, the transferring roller 220 rotates with the unidirectional restricting element 240, and the angular velocity of the transferring roller 220 is the same as the angular velocity of the unidirectional restricting element 240. Besides, the positioning element 250 is used to fix the transferring roller 220, the regulating element 230, and the unidirectional restricting element 240 on the shaft 210. Furthermore, the gasket 260 is disposed between the positioning element 250 and the unidirectional restricting element 240 for avoiding the mutual friction. The foregoing regulating element 230, unidirectional restricting element 240, positioning element 250, and gasket 260 can be applied and joined in the transmission assembly 200 selectively, and thus are not limitative of the present invention.

In the above embodiment, the transmission assembly 200 is described by an example of the pickup roller assembly. In other preferred embodiment, the transmission assembly 200 also can be the sheet-separating roller assembly or other roller assembly for transferring the data carriers P. The design of the transferring surface 222a configured with multiple grooves 224 and the design that at least one of two ends E1, E2 in each groove 224 is not contacted with the supporting surface 222b are all within the spirit and scope of this invention, and the present invention does not have any limitation.

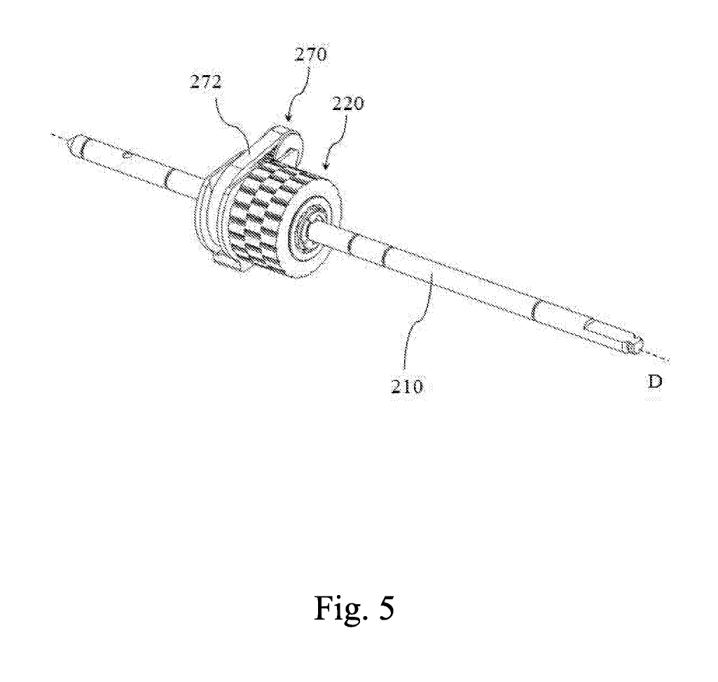

In addition, In the office machine of anther preferred embodiment (as shown in FIG. 5, which is a schematic view illustrating a transmission assembly according to another embodiment of the present invention), the transmission assembly also can comprises a belt-gears set 270. Wherein, two gear(not shown) are surrounded by the belt 272 of the belt-gears set 270. The belt 272 can provide a extension of the contacting surface for driving the data carriers P. Thus, The transmission assembly further makes the transport of the data carriers P more stably and smoothly by the assistance of the belt-gears set 270.

While the disclosure has been described by way of example and in terms of the preferred embodiments, it is to be understood that the disclosure is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A transferring roller, transferring a data carrier, the transferring roller comprising:
a body, having a transferring surface and two supporting surfaces, each supporting surface is connected to two sides of the transferring surface respectively; and
multiple grooves, arranged in the transferring surface, and each groove has two groove ends.

2. The transferring roller of claim 1, wherein at least one of the groove ends is not connected to the supporting surface.

3. The transferring roller of claim 1, further comprising multiple guiding units, the guiding units and the grooves are configured on the transferring surface along a pivoting axial and a feeding direction of the transferring roller in a spaced arrangement, and a tangent surface of the transferring surface along the pivoting axial is configured with the guiding unit and the groove simultaneously.

4. The transferring roller of claim 1, wherein the body is a wheel-like structure, the material of the body is rubber, and a housing space is located in the center of the body.

5. The transferring roller of claim 3, wherein the guiding units are arranged on the transferring surface entirely, and the guiding units configured in the tangent surface of the transferring surface along the pivoting axial are in the same horizontal plane, and part of the guiding units are connected with each other.

6. A transmission assembly, rotating along a feeding direction to transfer a data carrier, the transmission assembly comprising:
a shaft, disposed along a pivoting axial;
a transferring roller, pivoted with the shaft, and rotating in a axis of the pivoting axial, the transferring roller comprising:
a body, having a transferring surface and two supporting surfaces, each supporting surface is connected to two sides of the transferring surface respectively, and the supporting surfaces and the shaft are pivoted with each other; and
multiple grooves, arranged in the transferring surface, and each groove has two groove ends, at least one of the groove ends is not connected to the supporting surface.

7. The transmission assembly of claim 6, wherein the transferring roller further comprising multiple guiding units, the guiding units are arranged on the transferring surface in a spaced arrangement.

8. The transmission assembly of claim 7, wherein a tangent surface of the transferring surface along the pivoting axial is configured with the guiding unit and the groove simultaneously.

9. The transmission assembly of claim 6, wherein the body is a wheel-like structure, the material of the body is rubber, and a housing space is located in the center of the body.

10. The transmission assembly of claim 7, wherein the guiding units are arranged on the transferring surface entirely, and the guiding units configured in the tangent surface of the transferring surface along the pivoting axial are in the same horizontal plane, and part of the guiding units are connected with each other.

11. The transmission assembly of claim 6, further comprising:
a regulating element, disposed in the transferring roller;
a unidirectional restricting element, pivoted with the shaft, wherein the transferring roller is fixed around the unidirectional restricting element by the regulating element, the transferring roller rotates with the unidirectional restricting element, and the angular velocity of the transferring roller is the same as the angular velocity of the unidirectional restricting element;
a positioning element, fixing the transferring roller, the regulating element and the unidirectional restricting element in the shaft; and
a gasket, disposed between the positioning element and the unidirectional restricting element.

12. The transmission assembly of claim 6, further comprising a belt-gears set, pivoted with the shaft along the pivoting axial , and disposed aside of the transferring roller.

13. A office machine, comprising:
a data carrier transferring passage;
a transmission assembly, disposed in the data carrier transferring passage, and rotating to transfer a data carrier along a feeding direction, the transmission assembly comprising:
a shaft, disposed along a pivoting axial;
a transferring roller, pivoted with the shaft, and rotating in a axis of the pivoting axial, the transferring roller comprising:
a body, having a transferring surface and two supporting surfaces, each supporting surface is connected to two sides of the transferring surface respectively, and the supporting surfaces and the shaft are pivoted with each other; and
multiple grooves, arranged in the transferring surface, and each groove has two groove ends, at least one of the groove ends is not connected to the supporting surface.

14. The office machine of claim 13, wherein the transferring roller further comprising multiple guiding units, the guiding units are arranged on the transferring surface in a spaced arrangement.

15. The office machine of claim 14, wherein a tangent surface of the transferring surface along the pivoting axial is configured with the guiding unit and the groove simultaneously.

16. The office machine of claim 14, wherein the guiding units and the grooves are configured on the transferring surface along the pivoting axial and the feeding direction in a spaced arrangement.

17. The office machine of claim 13, wherein the body is a wheel-like structure, the material of the body is rubber, and a housing space is located in the center of the body.

18. The office machine of claim 14, wherein the guiding units are arranged on the transferring surface entirely, and the guiding units configured in the tangent surface of the transferring surface along the pivoting axial are in the same horizontal plane, and part of the guiding units are connected with each other.

19. The office machine of claim 13, wherein the transmission assembly further comprising:
a regulating element, disposed in the transferring roller;
a unidirectional restricting element, pivoted with the shaft, wherein the transferring roller is fixed around the unidirectional restricting element by the regulating element, the transferring roller rotates with the unidirectional restricting element, and the angular velocity of the transferring roller is the same as the angular velocity of the unidirectional restricting element;
a positioning element, fixing the positions of the transferring roller, the regulating element and the unidirectional restricting element on the shaft; and
a gasket, disposed between the positioning element and the unidirectional restricting element.

20. The office machine of claim 13, wherein the transmission assembly further comprising a belt-gears set, pivoted with the shaft along the pivoting axial, and disposed aside of the transferring roller.
